(19) United States
(12) Patent Application Publication
(10) Pub. No.: US 2024/0219657 A1
(43) Pub. Date: Jul. 4, 2024

(54) OPTICAL FIBER COUPLER AND ALIGNMENT METHOD

(71) Applicant: MO-LINK TECHNOLOGY LIMITED, Richmond (CA)

(72) Inventors: Hao WANG, Richmond (CA); Haitang QIN, Richmond (CA)

(21) Appl. No.: 18/544,178

(22) Filed: Dec. 18, 2023

Related U.S. Application Data
(60) Provisional application No. 63/437,037, filed on Jan. 4, 2023.

(51) Int. Cl. G02B 6/42

(52) U.S. Cl. CPC G02B 6/4214; G02B 6/423

(57) ABSTRACT

There is provided an optical coupler system. The system includes a first lens module including a first lens array positioned adjacent an emitting source. The first lens includes one or more collimating lenses. The system further includes a second lens module coupled to the first lens module. The second lens module may include alignment features. The system further includes a second lens array and an optical redirecting device providing a downstream second optical output, and an optical fibre cable integrally coupled to the second lens module.

### CROSS-REFERENCE TO RELATED APPLICATIONS

This claims the benefit of U.S. Provisional Patent Application No. 63/437,037, filed Jan. 4, 2023, the entire contents of which are incorporated herein by reference.

### FIELD

Embodiments of the present disclosure generally relate to the field of optical communications, and in particular to optical fiber coupler devices and alignment methods.

### BACKGROUND

Optical fiber coupler devices may be optical devices for propagating optical signals from a first device to a second device. For example, optical fiber coupler devices may connect two or more optical fiber ends allowing the transmission of optical signals across optical fibers. In another example, optical fiber coupler devices may propagate optical light emerging from a source emitter to an optical fiber cable for downstream optical light transmission. Optical fiber coupler devices may include one or more lenses through which optical light may pass.

### SUMMARY

The present disclosure describes embodiments of optical fiber coupler devices for propagating optical light to an end of an optical fiber for downstream optical signal transmission. In some scenarios, embodiments of optical fiber coupler devices may be for connecting two optical fiber ends allowing transmission of optical signals across the optical fibers.

When light energy density is relatively high (e.g., focused optical light) at an interface between adjacent mediums, an alignment tolerance specification associated with aligning mediums at the interface may be relatively stringent.

For example, when an optical fiber coupler provides focused light output at a coupler output to an optical fiber, the extent that the coupler output is precisely aligned with the optical fiber end may affect the optical light signal quality for downstream propagation. It may be desirable to provide optical fiber coupler devices for propagating optical light across adjacent mediums whilst reducing the stringent nature of the alignment tolerance specification. Further, it may be desirable to provide optical fiber coupler devices with features for allowing production line quality control testing of lens modules included in the optical fiber coupler devices.

The present disclosure describes embodiments of optical fiber coupler devices including lens configurations for reducing light energy density at an interface between lens modules, and for propagating the optical light into ends of optical fibers for downstream optical light transmission. Accordingly, a misalignment tolerance specification at the interface between lens modules need not be as stringent as compared to when light energy density at an interface between adjoining mediums may be comparatively higher. Based on embodiments described in the present disclosure, increased manufacturing or assembly yields of optical fiber couplers to optical fibers may be achieved.

In an aspect, the present disclosure provides an optical fiber coupler system comprising elements described and/or illustrated in the present disclosure.

In another aspect, the present disclosure provides an optical fiber coupler method comprising operations described an/or illustrated in the present disclosure.

In another aspect, the present disclosure provides an optical fiber coupler system. The optical fiber coupler system includes a first lens module including a first lens array positioned adjacent an emitting source, the first lens module including one or more collimating lenses providing a first optical output having reduced optical light energy density as compared to optical light emerging from the emitting source; a second lens module coupled to the first lens module, the second lens module including: alignment features aligning the second lens module with the first lens module at the interface region, wherein the optical light energy density at the interface region is lower as compared to optical light emerging from the emitting source; and a second lens array including one or more focusing lenses and an optical redirecting device providing a downstream second optical output; and an optical fiber cable integrally coupled to the second lens module to receive the second optical output.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a schematic view of an optical coupler system, in accordance with an embodiment of the present disclosure;

FIG. 2 illustrates a schematic view of an optical coupler system, in accordance with another embodiment of the present disclosure;

FIG. 3 illustrates a perspective view of a first lens module coupled to a second lens module, in accordance with embodiments of the present disclosure;

FIG. 4 illustrates a top perspective view of the first lens module of FIG. 2;

FIG. 5 illustrates a bottom perspective view of the first lens module of FIG. 2;

FIG. 6 illustrates a top perspective view of the second lens module of FIG. 2;

FIG. 7 illustrates a bottom perspective view of the second lens module of FIG. 2;

FIG. 8 illustrates a bottom plan view of the second lens module of FIG. 2;

FIG. 9 illustrates a cross-sectional view of the second lens module at A-A of FIG. 8; and

FIG. 10 illustrates a plan view of a substrate for receiving the first lens module, in accordance with embodiments of the present disclosure.

### DETAILED DESCRIPTION

Optical coupler systems may include devices for transmitting optical signals from a first medium to a second medium. As an example, a laser emitting device emitting divergent light may be coupled for transmission along an optical fiber. Optical coupler systems including lens modules may be provided as an optical path design for transmitting light signals from a first end point to a second endpoint.

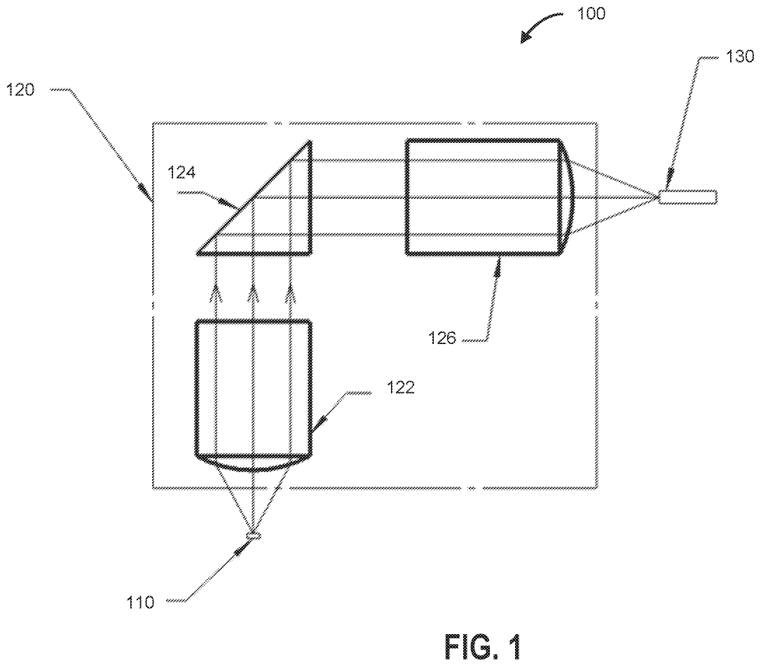

Reference is made to FIG. 1, which illustrates a schematic view of an optical coupler system 100, in accordance with an embodiment of the present disclosure. The optical coupler system 100 includes a lens module 120 for coupling optical signals from a emitting source 110 to a optical fiber cable 130. The optical fiber cable 130 may include one or more optical fibers configured to transmit light.

In some examples, the emitting source 110 may be a laser beam device. Other types of emitting sources 110 may be used. The emitting source 110 may provide divergent light output.

The lens module 120 may include a collimating lens 122 and a focusing lens 126 configured to couple optical signals from the light emitting source 110 to the optical fiber cable 130. In some embodiments, the lens module 120 may include a redirecting device 124 configured to alter direction of optical signals. In some embodiments, the redirecting device 124 may be configured for redirecting optical signals by substantially 90 degrees. Other redirecting devices 124 for redirecting optical signals by other angles may be used.

Thus, in some implementations, the optical coupler system 100 may include one or more optical components coupling an emitting source 110 and an optical fiber array. The emitting source 110 may be a vertical-cavity surface-emitting laser (VCSEL) chip array to emit light signals for transmission by the optical fiber cable 130. The optical fiber cable 130 may include an array of optical fibers positioned parallel to one another and fixed on an optical fiber carrier device. The optical fiber carrier device may be aligned based on a series of guiding apertures and guiding posts. In the present example, the lens module 120 having the one or more optical components and the optical fiber carrier device may be constructed based on injection molding operations.

In some example injection molding operations, specifications for producing guide apertures may have a guide aperture diameter tolerance range of 0 to 5 μm. Specifications for producing guide columns may have a guide column diameter tolerance range of −5 to 0 μm. As it may be desirable to have matching properties, the tolerance of a device feature may be positive, while the tolerance of a corresponding feature may be negative. In the present example, specifications for the position of one or more guide holes and one or more corresponding guide columns may be have a tolerance range of −5 μm to 5 μm. In some scenarios, additive tolerance ranges may cause the positioning of optical fibers relative to corresponding lenses to be eccentric. Thus, the mismatch in position among respective optical fibers and corresponding lenses may exceed 10 μm.

As light entering an optical fiber cable 130 may be focused light having relatively focus spot light energy density, such observed eccentricity among respective optical fibers and corresponding lenses may result in reduced component alignment thereby leading to reduced optical coupler system production yields.

Further, in scenarios where optical coupler systems may be produced based on injection moulding processes, guide holes or guide posts constructed of plastic materials may be susceptible to deformation, thereby affecting a desired roundness or verticality of the optical coupler system setup. In scenarios where guide posts are damaged, there may be greater quantities of material waste and reduction of optical coupler system production yields.

Based on the example optical coupler system 100 described with reference to FIG. 1, misalignment of the lens module 120 output relative to an adjoining optical fiber 130 may lead to unstable propagation of optical signals to the optical fiber 130. That is, eccentricity among respective optical fibers and corresponding lenses of the lens module 120 may result in reduced optical coupler system production yields at least because optical signals may not be successfully transmitted from the emitting source 110 onward to the optical fiber 130.

In some scenarios, when light energy density is relatively high (e.g., focused optical light) at an interface between adjacent mediums, an alignment tolerance specification associated with aligning mediums at the interface may be relatively stringent.

For example, when an optical fiber coupler provides focused light output at a coupler output to an optical fiber, the extent that the coupler output is precisely aligned with the optical fiber end may affect the optical light signal quality for downstream propagation. It may be desirable to provide optical fiber coupler devices for propagating optical light across adjacent mediums whilst reducing the stringent nature of the alignment tolerance specification. Further, it may be desirable to provide optical fiber coupler devices with features for allowing production line quality control testing of lens modules included in the optical fiber coupler devices.

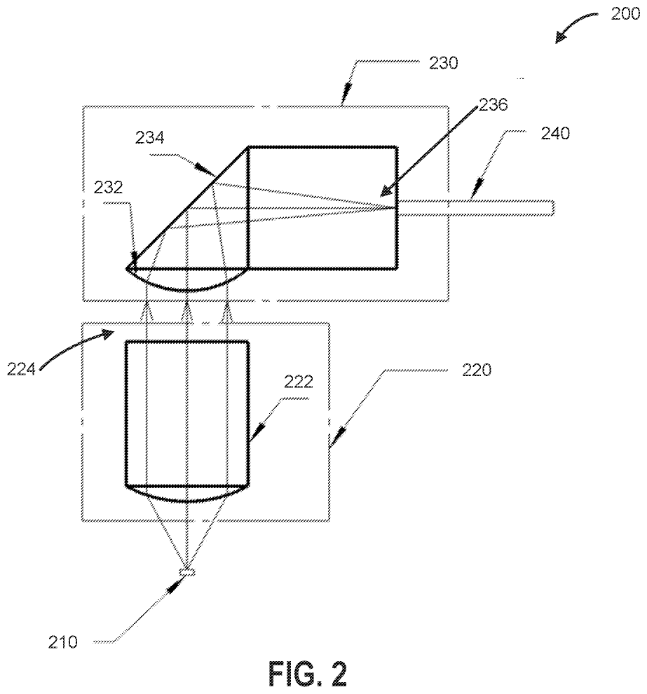

Reference is made to FIG. 2, which illustrates a schematic view of an optical coupler system 200, in accordance with another embodiment of the present disclosure. The optical coupler system 200 includes a first lens module 220 and a second lens module 230.

The first lens module 220 includes a collimating lens 222 for receiving optical signals from an emitting source 210. The first lens module 220 receives divergent light from the emitting source 210 and provides a first optical output 224. The first optical output 224 may include aligned optical signals (akin to parallel beams of light signals). The first optical output 224 may have a light energy density that is relatively lower as compared to the light energy density emitted by the emitting source 210.

In some embodiments, the second lens module 230 includes a focusing lens 232 for receiving the first optical output 224. The region between the first optical output 224 and the focusing lens 232 may be an interface region between the first lens module 220 and the second lens module 230.

The focusing lens 232 in combination with an optical redirecting device 234 may redirect the first optical output 224 to provide a second optical output 236 at an opening of an optical fiber 240. In some embodiments, positioning of the focusing lens 232 relative to the optical redirecting device 234 may be adjusted to provide alignment of the second optical output 236 and the opening of the optical fiber cable 240 at the interface of the second lens module 230 and the optical fiber cable 240.

In some embodiments, the optical redirecting device 234 may redirect optical light by approximately 90 degrees. In some other embodiments, the optical redirecting device 234 may redirect optical light other degree values based on a required physical configuration of the optical fiber coupler device.

To provide substantially precise alignment of the second optical output 236 at the opening of the optical fiber cable 240, in some embodiments, the second lens module 230 may integrally position the focusing lens 232 and the optical fiber cable 240 based on injection molding operations. Accordingly, the optical fiber cable 240 may be affixed to an alignment position relative to the second lens module 230.

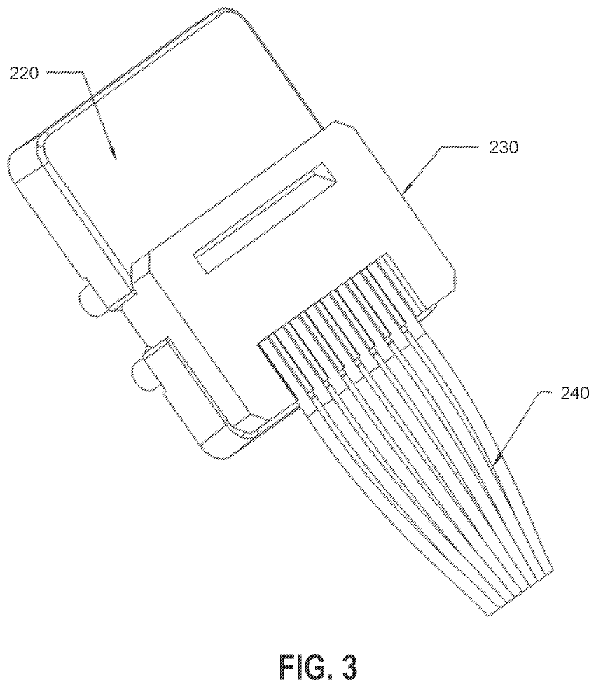

Reference is made to FIG. 3, which illustrates a perspective view of the first lens module 220 coupled to the second lens module 230, in accordance with embodiments of the present disclosure. The combination of the first lens module 220 and the second lens module 230 may be configured to convey optical signals from an emitting source (not explicitly shown in FIG. 3) to the optical fiber cable 240 having a plurality of optical fibers. In some embodiments, the first lens module 220 may be removably affixed to the second lens module 230.

To couple optical signals from an emitting source 210 to the optical fiber cable 240 with substantially precise alignment, it may be desirable to provide optical coupler system features for aligning the first lens module 220 and the second lens module 230.

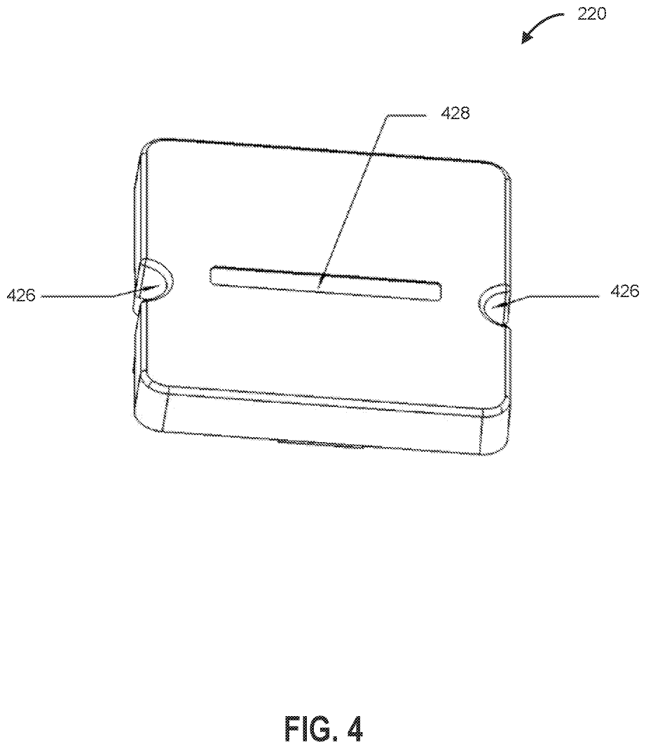

To illustrate, FIG. 4 shows a top perspective view of the first lens module 220 (FIG. 2). The first lens module 220 includes one or more guiding apertures 426 and an optical output slot 428 through which the first optical output 224 (FIG. 2) may emerge towards the second lens module 230.

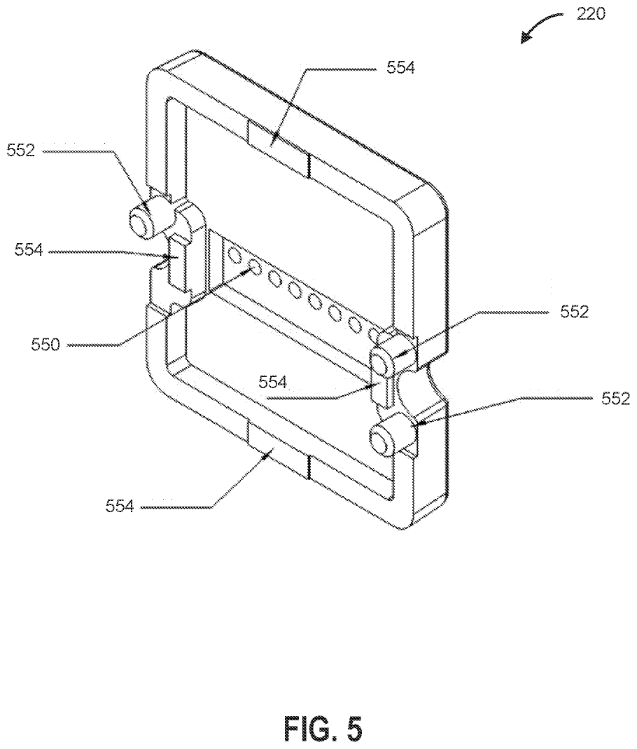

FIG. 5 illustrates a bottom perspective view of the first lens module 220. The first lens module 220 may be formed from an injection molded frame, and may include a first lens array 550. The lens array 550 may include one or more collimating lenses 222 for receiving optical signals from the emitting source 210 (FIG. 2). For example, the one or more collimating lenses 222 may be for receiving optical signals from a respective emitting source 210.

The first lens module 220 may include one or more guiding columns 552. The one or more guiding columns 552 may be configured to align with substrate apertures (not explicitly illustrated in FIG. 5). The substrate apertures may be on a substrate, and the substrate may be configured to receive the first lens module 220 thereon. As an example, the substrate may be a printed circuit board having one or more emitting sources 210 positioned thereon. Alignment of the one or more guiding columns 552 (of the first lens module 220) with respective substrate apertures may thereby align the one or more emitting sources 210 with respective collimating lenses 222 of the lens array 550.

The first lens module 220 may include one or more reference planes 554. The one or more reference planes 554 may provide a surface on which the first lens module 220 may interface with an adjoining substrate. In some embodiments, the one or more reference planes 554 may be dimensioned such that the respective collimating lenses 222 are positioned at a substantially similar distance to the corresponding emitting source 210 as adjacent collimating lenses 222 in the lens array 550.

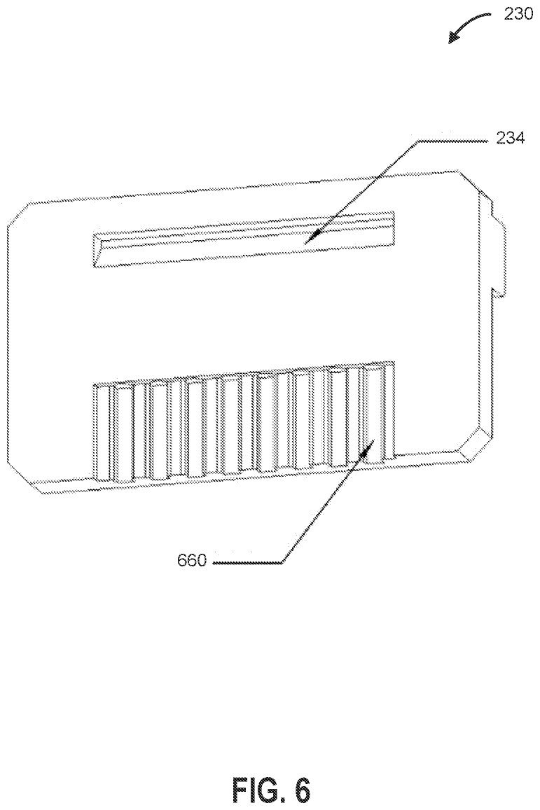

Reference is made to FIG. 6, which illustrates a top perspective view of the second lens module 230 (FIG. 2). The second lens module 230 includes the redirecting device 234 (FIG. 2). As described herein, the redirecting device 234 may be configured in combination with the focusing lens 232 (FIG. 2) for receiving the first optical output 224 and redirecting the optical signal to the optical fiber cable (not explicitly shown in FIG. 6). In some embodiments, the optical fiber cable may be integrally affixed in an alignment position relative to the second lens module 230 such that the first optical output 224 may be received, refocused, or redirected by the combination of the focusing lens 232 and the redirecting device 234 into a respective optical fiber of the optical fiber cable.

The second lens module 230 includes one or more peripheral fiber grooves 660 for positioning an end of a respective optical fiber adjacent to the redirecting device 234.

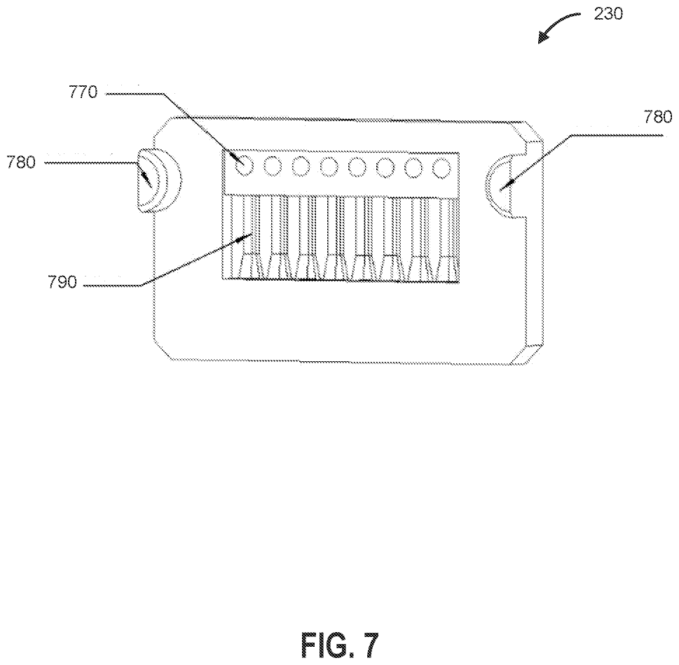

FIG. 7 illustrates a bottom perspective view of the second lens module 230. The second lens module 230 includes a second lens array 770. The second lens array 770 includes one or more focusing lenses 232 configured for receiving the first optical output 224.

The second lens module 230 may include guiding protrusions 780 configured for being received within corresponding one or more guiding apertures 426 (FIG. 4) of the first lens module 220. Alignment and receipt of the guiding protrusions 780 with corresponding guiding apertures 426 positions the second lens module 230 relative to the first lens module 220 such that first optical output 224 from the first lens module 220 is aligned with and received by respective focusing lenses 232 of the second lens array 770.

The second lens module 230 may include one or more proximal fiber grooves 790 for positioning the end of the respective optical fiber adjacent to the redirecting device 234. By positioning the end of the respective optical fiber adjacent to the redirecting device 234, the second optical output 236 (FIG. 2) may be provided to and transmitted along one or more optical fiber components.

In some embodiments, optical fiber cable 240 may include one or a bundle of optical fibers. Beginning at an end portion of the respective optical fibers, diameters of the respective fibers may progressively increase. For example, the optical fibers may have a 125 μm diameter at end portions of the respective fibers, and may have a 245 μm diameter inward from the end portion of the respective fibers.

In some embodiments, the one or more proximal fiber grooves 790 may be configured as V-shaped grooves, and may be configured for positioning or fixing a smaller diameter portion of the optical fiber. Further, the one or more peripheral fiber grooves 660 (FIG. 6) may be configured for positioning or fixing a larger diameter portion of the optical fiber. Continuing with the above example, the one or more peripheral fiber grooves 660 may be configured for positioning or fixing a 245 μm portion of the optical fibers, and the one or more proximal fiber grooves 790 may be configured for positioning or fixing a 125 μm diameter end portion of the respective optical fibers. Other optical fiber end dimensions may be used.

In some embodiments, the second lens array 770 may include the combined focusing lens 232 and the redirecting device 234 having a corresponding mapping to a grove of the one or more proximal fiber grooves 790. Based on features of the second lens module 230, observed eccentricity caused by the injection molding operations among respective optical fibers and corresponding lenses of the second lens array 770 may be minimized to a tolerance of approximately +/−2 μm.

Because the one or more proximal grooves 790 are on a similar side as the second lens array 770, in some scenarios, production line test and inspection of alignment of the respective optical fibers relative to the second lens array 770 may be conducted with relative ease.

As described, the one or more peripheral fiber grooves 660 (FIG. 5) may be configured for positioning or fixing a 245 μm (e.g., larger diameter portion of the optical fibers) portion of the optical fibers, and may provide the structural components for guiding optical fibers into the second lens module 230.

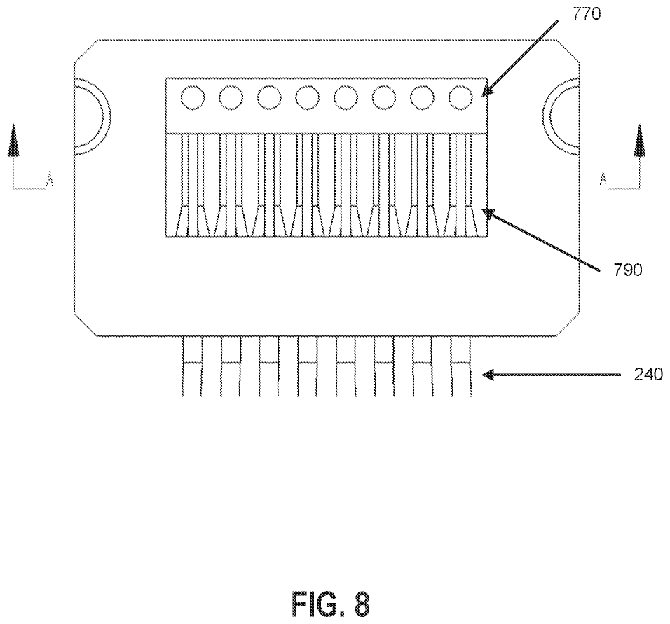

FIG. 8 shows a bottom plan view of the second lens module 230 (FIG. 2). In FIG. 8, a plurality of optical fibers of the optical fiber 240 are shown to be received by the combination of peripheral grooves 660 (not explicitly shown in FIG. 8) and the proximal grooves 790.

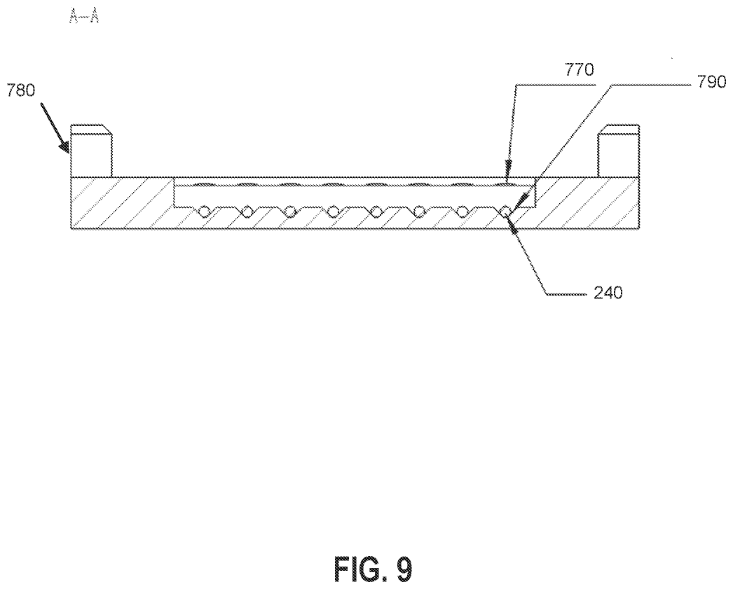

FIG. 9 shows a cross-sectional view of the second lens module 230 at A-A of FIG. 8. When the second lens module 230 is positioned and mated with the first lens module 220, the first optical output 224 may be provided to the second lens array 770. The one or more focusing lenses 232 combined with the adjacent redirecting device 234 may provide optical signals to the optical fiber cable 240, and more particularly optical signals to the respective optical fibers of the optical fiber cable 240.

Referring again to FIG. 2, the first optical output 224 at the interface region between the first lens module 220 and the second lens module 230 may have a light energy density that may be relatively lower as compared to light energy density of optical light emerging from the emitting source 210. Accordingly, a misalignment tolerance specification at the interface between lens modules may not need to be as stringent as compared to when light energy density at an interface adjoining mediums may be comparatively higher.

Referring again to FIGS. 6 and 7, the peripheral fiber grooves 660 and proximal fiber grooves 790 may be dimension with triangular, cylindrical, or other profiles for precisely positioning optical fibers adjacent respective lenses of the second lens array 770. The respective optical fibers may then be affixed at an aligned position for receiving the second optical output 236. Although the second optical output 236 may have a light energy density that may be relatively higher than the light energy density of the first optical output 224, the optical fibers may be integrally fixed relative to respective lenses of the second lens array 770.

In some embodiments, the cross-sectional profile of the peripheral fiber grooves 660 or the proximal fiber grooves 790 may be dimensioned to position and align optical fiber ends relative to the respective adjacent lenses of the second lens array 770 within an alignment tolerance value. For example, as illustrated in FIG. 9, the cross-sectional profile of the proximal fiber grooves 790 may be a triangular or saw-tooth profile.

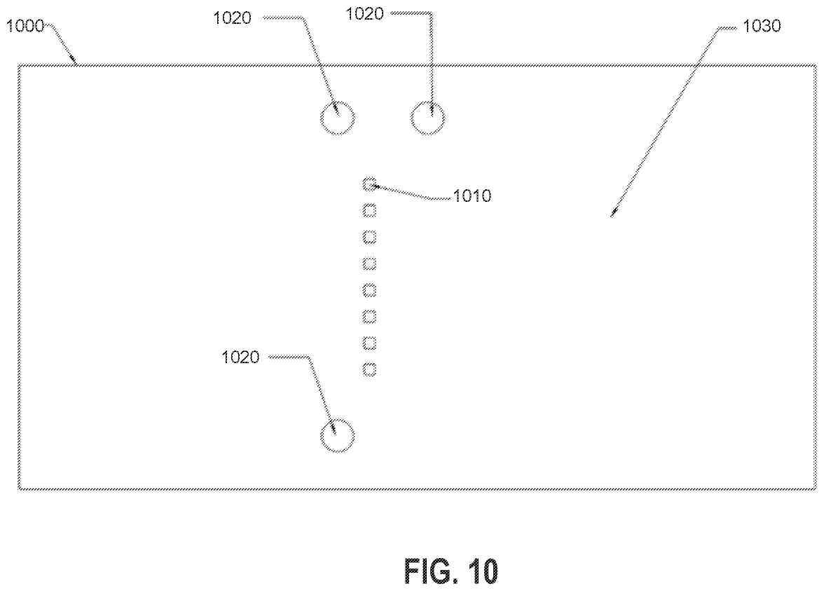

FIG. 10 illustrates a plan view of a substrate 1000 for receiving the first lens module 220, in accordance with embodiments of the present disclosure. In some examples, the substrate 1000 may be a printed circuit board. Other types of substrates 1000 for supporting embodiments of lens modules disclosed herein may be used.

The substrate 1000 may include one or an array of emitting sources 1010, such as a laser array. The array of emitting sources may be energized and modulated for generating optical signals based on electrical connection traces on or within the substrate 1000. For example, the substrate 1000 may be a printed circuit board.

The substrate 1000 may include substrate apertures 1020 positioned to correspond to the configuration of the one or more guiding columns 552 of the first lens module 220. In situations where the one or more guiding columns 552 are received within the substrate apertures 1020, the first lens module 220 may be positioned such that the respective emitting sources 1010 are substantially aligned with a corresponding collimating lens 220 of the first lens module.

In some embodiments, the one or more emitting sources 1010 may be positioned on the substrate 1000 generally between substrate apertures 1020 on opposing sides of the substrate 1000. The distance between or among the plurality of emitting sources 1010 may correspond to the distance between or among: (1) corresponding collimating lenses 222 of the first lens array 550; and/or (2) corresponding focusing lenses 232 of the second lens array 77-.

Referring again to FIG. 2, in some embodiments of the present disclosure, one or more emitting sources may emit divergent optical signals and be provided to the series of the first lens module 220 and the second lens module 230. The first lens module 220 may collimate the received divergent optical signals and provide a first optical output 224. The light energy density of the first optical output 224 may be relatively lower as compared to the light energy density of the optical light emitted by the one or more emitting sources.

The second lens module 230 may receive the first optical output 224 (e.g., collimated optical signals), and a combination of one or more focusing lenses 232 and the adjacent redirecting device 234 may provide focused optical signals to an end of the optical fiber cable 240. In some embodiments, the adjacent redirecting device 234 may be configured as a “45 degree turning surface” such that the overall incident first optical output 224 may be redirected substantially 90 degrees from the angle of incidence at the second lens module 230 for providing optical signal output at the end of the optical fiber cable 240. Other magnitudes of optical light redirection may be used based on the physical device requirements.

Further, alignment of the first lens module 220 relative to the second lens module 230 may be based on receipt of the one or more guiding protrusions 780 within the one or more guiding apertures 426. Upon receipt of the one or more guiding protrusions a within the one or more guiding apertures 426, collimating lenses 222 of the first lens array 550 may be in alignment with corresponding focusing lenses 232 of the second lens array 770. Based on one or more features of the optical coupler system described herein, there may be reduced eccentricity among respective optical fibers and corresponding lens components.

The optical signal path from the first lens module 220 to the second lens module 230 may include optical signals having parallel optical light having comparatively lower light energy density as compared to the light energy density of emitted optical light from the emitting source. Accordingly, a misalignment tolerance specification associated with the combination of the one or more guiding protrusions 780 (of the second lens module 230) and the guiding apertures 426 (of the first lens module 220) may need not be as stringent as compared to when light energy density at an interface between adjoining mediums may be comparatively higher.

A method of assembling an optical coupler system may be provided.

The first lens module 220 may be positioned and aligned on a substrate 1010 (FIG. 10). The first lens module 220 may include one or more guiding columns 552 (FIG. 5). The guiding columns 552 may be aligned with the substrate apertures 1020 (FIG. 10) for aligning the one or more emitting sources 1010 (FIG. 10) with the first lens array 550 (FIG. 5).

In some embodiments, alignment of the first lens module 220 on the substrate 1010 may have a defined direction. For example, the substrate 1010 may include three or more substrate apertures 1020 corresponding to three or more guiding columns 552, such that the first lens module 220 may be prevented from being positioned on the substrate 1010 in an undesired orientation that may be 180 degrees from a desired placement position.

The first lens module 220 may be positioned at an elevation relative to the substrate 1010 based on one or more reference planes 554 (FIG. 5). The one or more reference places 554 of the first lens module 220 may interface with a surface of the substrate 1010 and may position the first lens module 220 such that the respective lenses of the first lens array 550 are at substantially similar distance to the emitting sources as other lenses of the first lens array 550.

In some embodiments, the first lens module 220 may be affixed to the substrate 1010 using adhesive to provide a laser collimation module.

In some embodiments, the second lens module 230 may be integrally affixed to an optical fiber cable 240 (FIG. 8). The optical fiber cable 240 may include one or more optical fibers received within corresponding peripheral fiber grooves 660 or proximal grooves 790. The respective peripheral fiber grooves 660 or proximal grooves 790 may be dimensioned with a cross-sectional profile such that the position of a cross-sectional center of the optical fibers may be aligned with a center position of a corresponding lens of the focusing lenses 232.

In some embodiments, the optical fibers of the optical fiber cable 240 may be affixed to the respective proximal fiber grooves 790 with refractive index matching adhesive. In some embodiments, portions of the optical fibers of the optical fiber cable 240 may be affixed to the respective peripheral fiber grooves 660 with refractive index matching adhesive or other types of adhesives. Other types of adhesives may be used for affixing ends of the optical fibers to the proximal fiber grooves 790 or the peripheral fiber grooves 660.

In some embodiments, the second lens module 230 may be coupled to the first lens module 220 when the one or more guiding protrusions 780 (of the second lens module 230) are received within corresponding guiding apertures 426 (of the first lens module 220). In some embodiments, the misalignment tolerance specification may be defined as within 10 μm. It may be appreciated that in some scenarios where the light energy density of the first optical output 224 may be comparatively high (e.g., being focused optical light), the misalignment tolerance specification may need to be more stringent, and be defined as less than 10 μm.

In some embodiments, the first lens module 220 and the second lens module 230 may be adhesively affixed for securing the lens modules. Accordingly, optical light emitted by the emitting source 210 may be coupled to the optical fiber cable 240 based on lens configurations that may lessen a misalignment tolerance specification. In some embodiments, injection molding operations may be used for constructing the lens modules.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

As can be understood, the examples described above and illustrated are intended to be exemplary only.

What is claimed is:

1. An optical fiber coupler system comprising:
a first lens module including a first lens array positioned adjacent an emitting source, the first lens module including one or more collimating lenses providing a first optical output having reduced optical light energy density as compared to optical light emerging from the emitting source;
a second lens module coupled to the first lens module, the second lens module including:
alignment features aligning the second lens module with the first lens module at the interface region, wherein the optical light energy density at the interface region is lower as compared to optical light emerging from the emitting source; and
a second lens array including one or more focusing lenses and an optical redirecting device providing a downstream second optical output; and
an optical fiber cable integrally coupled to the second lens module to receive the second optical output.

2. The optical fiber coupler system of claim 1, wherein the second lens module includes one or more fiber grooves positioning respective optic fibers of the optical fiber cable.

3. The optical fiber coupler system of claim 2, wherein the one or more fiber grooves include at least one of a triangular or saw-tooth cross-sectional profile.

4. The optical fiber coupler system of claim 2, wherein the respective optic fibers are affixed within fiber grooves and coupled to focusing lenses using a refractive index matching adhesive.

5. The optical fiber coupler system of claim 1, wherein the optical redirecting device is for providing downstream second optical output that is based on the first optical output redirected substantially 90 degrees in direction.

6. The optical fiber coupler system of claim 1, wherein the optical redirecting device is for providing downstream second optical output that is based on the first optical output redirected by greater than 90 degrees in direction.

7. The optical fiber coupler system of claim 1, wherein the second optical output is focused optical light output having a light energy density greater than the light energy density of the first optical output.

8. The optical fiber coupler system of claim 1, wherein the first lens module includes guiding apertures,
and wherein the alignment features for aligning the second lens module with the first lens module include one or more guiding protrusions for receipt within corresponding guiding apertures of the first lens module.

9. The optical fiber coupler system of claim 1, comprising a substrate for positioning the emitting source, wherein the substrate includes one or more substrate apertures on opposing sides of the emitting source,
and wherein the first lens module includes one or more guiding columns to align with respective substrate apertures for positioning the first lens module relative to the emitting source.

10. The optical fiber coupler system of claim 9, wherein the first lens module includes one or more reference planes interfacing with the substrate for positioning the respective collimating lenses to be at substantially similar distance from a corresponding emitting source as other collimating lenses of the first lens module.

11. An optical fiber coupler system comprising elements described and/or illustrated herein.

12. An optical fiber coupler method comprising operations described and/or illustrated herein.
